(19) United States
(12) Patent Application Publication
(10) Pub. No.: US 2013/0016503 A1
(43) Pub. Date: Jan. 17, 2013

(54) SELF-BALLASTED TUBE AND LUMINAIRE HAVING THE TUBE

(71) Applicants: Nim Chung Ku, Shenzhen (CN); Jiahua Lou, Shenzhen (CN); Harald Dellian, Edling (DE); Huajian Fan, Shenzhen (CN)

(72) Inventors: Nim Chung Ku, Shenzhen (CN); Jiahua Lou, Shenzhen (CN); Harald Dellian, Edling (DE); Huajian Fan, Shenzhen (CN)

(73) Assignee: OSRAM AG, Muenchen (DE)

(21) Appl. No.: 13/636,340

(22) PCT Filed: Mar. 8, 2011
(86) PCT No.: PCT/EP2011/053409

§ 371 Date: Sep. 21, 2012

(30) Foreign Application Priority Data
Mar. 23, 2010 (CN) 201010130235.4

(51) Int. Cl. F21V 21/04; H01R 33/22

(52) U.S. Cl. 362/217.13; 362/217.17

(57) ABSTRACT

In various embodiments, a self-ballasted light emitting diode (LED) tube may include an LED lamp body; and an LED driver module; wherein the LED driver module is configured to drive the LED lamp body for lighting; wherein the LED driver module and the LED lamp body are removably connected.

### TECHNICAL FIELD

The present invention relates to a self-ballasted LED tube and a luminaire having the tube.

### BACKGROUND

LED is a widely used light source with a relatively long time usage. In the self-ballasted LED tube in the prior art, an LED driver and an LED lamp body are usually integrated together, and the end user cannot remove the driver from the tube. However, since the lifetime of the driver varies very much, in cases where the driver with a relatively short lifetime is mounted, if the driver fails and cannot be used, the whole tube consequently needs to be replaced, which reduces the whole lifetime of the tube. In addition, when checking a failure of the self-ballasted LED tube related to the driver, the whole tube needs to be completely disassembled by breaking or dis-soldering component or some other manners to dismantle the driver for failure check, which complicates the process of failure check.

Therefore, it is an urgent demand to solve the above one or more shortcomings.

### SUMMARY OF THE INVENTION

The technical problem to be solved by the present invention is to provide a self-ballasted LED tube with a relatively long lifetime, and an end user can maintain a long lifetime of the whole LED tube by replacing the LED driver module in the LED tube, so that the LED driver is not necessary to be designed with the same lifetime as the LED lamp body.

The present invention provides a self-ballasted LED tube, comprising an LED lamp body and an LED driver module, the LED driver module drive the LED lamp body for lighting, characterized in that the LED driver module and the LED lamp body are removablely connected. By designing the LED driver module and the LED lamp body to be removablely connected, the end user can remove the LED driver module with a relatively short lifetime when the LED driver module fails and cannot be used, and replace the LED driver module with a new LED driver module, so that the tube can be used continuously, which prolongs the usage lifetime of the tube and avoids economic loss caused by unnecessary replacement of the whole tube.

According one improved solution of the present invention, the LED driver module is arranged at an end of the LED lamp body, consequently, it is easy to remove the LED driver module, when it fails and cannot be used, from the LED lamp body.

Preferably, the LED driver module comprises a first driver unit and a second driver unit respectively located at one of two ends of the LED lamp body and forming a whole LED driver module.

According one embodiment of the present invention, the LED lamp body comprises a tube lamp shell and an LED assembly arranged in the tube lamp shell, the LED driver module comprises a driver casing and a driver arranged in the driver casing, the tube lamp shell and the driver casing are nested and locked together to removablely connect the LED driver module and the LED lamp body.

In order to accomplish electrical connection between the LED driver module and the LED lamp body, in one embodiment, the tube lamp shell has a first contact at an end of the tube lamp shell which is electrically connected to the LED assembly; the driver casing has a second contact electrically connected to the driver at an end facing the tube lamp shell; the first contact and the second contact are correspondingly designed, for instance, the two can be in plugged contact or contacted by points. The first contacts and the second contact are spring contacts or contact rings.

In order to realize mechanically removable connection between the tube lamp shell and the driver casing, the tube lamp shell comprises a first opening opened thereon, the second contact has a second opening thereon, then, the LED driver module and the LED lamp body are removablely connected by aligning the first opening with the second opening and locking them with a locking means such as screw. In assembling, the first opening and the second opening are aligned and locked by a screw; in disassembling, the screw is unscrewed and the driver casing is separated from the tube lamp shell, thus, the LED driver module is separated from the LED lamp body. Alternatively, the tube lamp shell comprises a first thread portion, the driver casing comprises a second thread portion, and the LED driver module and the LED lamp body are removablely connected by screwing together the first thread portion and the second thread portion.

The present invention further relates to a luminaire comprising the self-ballasted LED tube having the above features.

The present invention enables rapid replacement of the LED driver module, which thus greatly prolongs the lifetime of the self-ballasted LED tube and corresponding luminaire, and reduces complexity in the process of maintaining the LED drier module. Moreover, the modular concept makes it much easier designing, manufacturing and material stock.

### BRIEF DESCRIPTION OF THE DRAWINGS

The present invention will be further explained in connection with the drawings and the embodiments:

FIG. 1 is a schematic diagram of the self-ballasted LED tube in a state when the LED driver module and the LED lamp body are being assembled according to the first embodiment of the present invention;

FIG. 2 is a schematic diagram of the self-ballasted LED tube in the process when the LED driver module and the LED lamp body are being disassembled according to the first embodiment of the present invention;

FIG. 3 is a schematic diagram of the self-ballasted LED tube when the LED driver module and the LED lamp body are completely separated according to the first embodiment of the present invention;

FIGS. 4 and 5 show the electrical connection and mechanical connection between the LED driver module and the LED lamp body from two different angles according to the first embodiment of the present invention.

FIGS. 6, 7 and 8 show the electrical connection and mechanical connection between the LED driver module and the LED lamp body according to the second embodiment of the present invention.

### DETAILED DESCRIPTION OF THE EMBODIMENTS

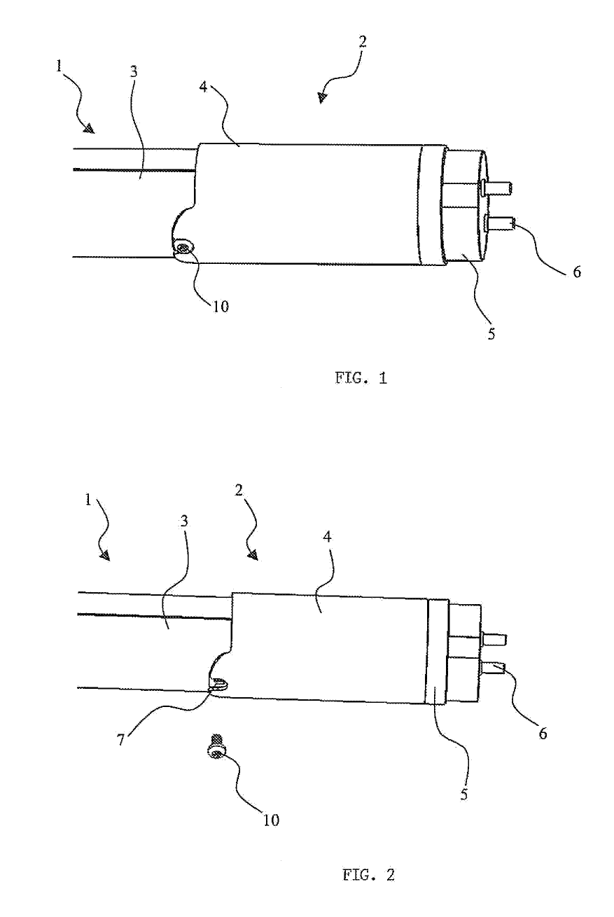

FIG. 1 is a schematic diagram of the self-ballasted LED tube in a state when an LED driver module 2 and an LED lamp body 1 are being assembled according to the first embodiment of the present invention. From FIG. 1 it could be seen that the self-ballasted LED tube comprises an LED lamp body 1 and an LED driver module 2. The LED lamp body 1 is supplied with power by the LED driver module 2 for lighting of the self-ballasted LED tube.

The LED lamp body 1 comprises parts, such as a tube lamp shell 3 and an LED assembly (not shown) contained in the tube lamp shell 3, necessary for LED lighting. Since the improvement of the present invention does not lie in the parts such as the LED assembly contained in the tube lamp shell 3, they will not be described in detail.

The LED driver module 2 comprises parts, such as a driver casing 4, a driver (not shown) end cover 5 and a base of the lamp 6 arranged in the driver casing 4, necessary for driving the LED lamp body 1 for lighting. Similarly, since the improvement of the present invention does not lie in the specific design of the driver, the end cover 5 and the base of the lamp 6, they will not be described in detail.

In the self-ballasted LED tube of the present invention, the LED driver module 2 and the LED lamp body 1 are removablely connected. That is to say, though both of them belong to one part of the self-ballasted tube, a modular concept is used to respectively design and manufacture the LED driver module 2 and the LED lamp body 1 and to removablely connect the two so as to ensure that it is easy to replace the LED driver module when the LED driver module fails and cannot be used.

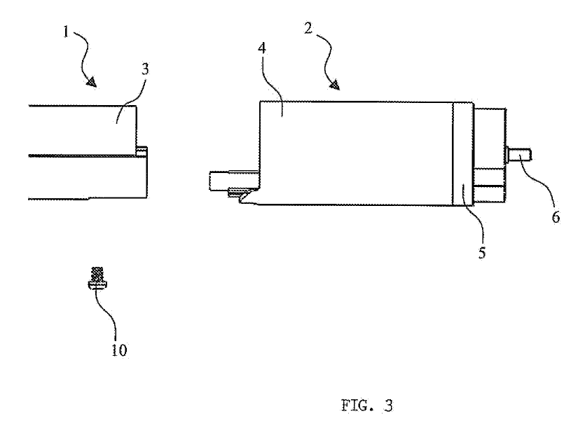

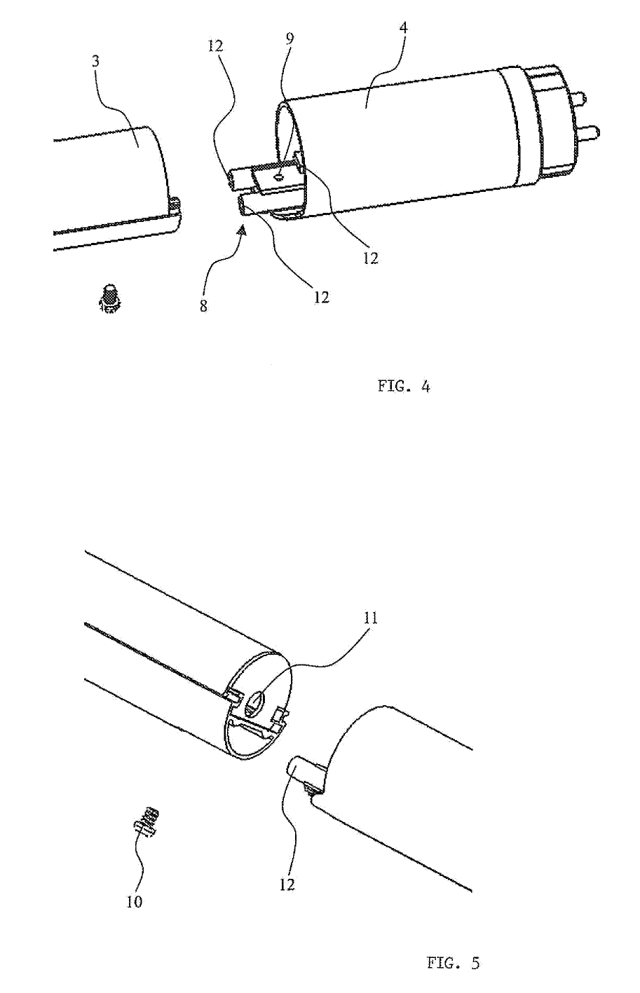

FIG. 2 is a schematic diagram of the self-ballasted LED tube in the process when the LED driver module and the LED lamp body are being disassembled according to the first embodiment of the present invention; and FIG. 3 is a schematic diagram when the two are completely separated. By combining FIGS. 1, 2, 3 it could be seen that the mechanically removable connection between the LED driver module 2 and the LED lamp body 1 is realized by means of a screw 10, a first opening 7 opened on the tube lamp shell 3 together with a second opening 9 in the driver casing 4.

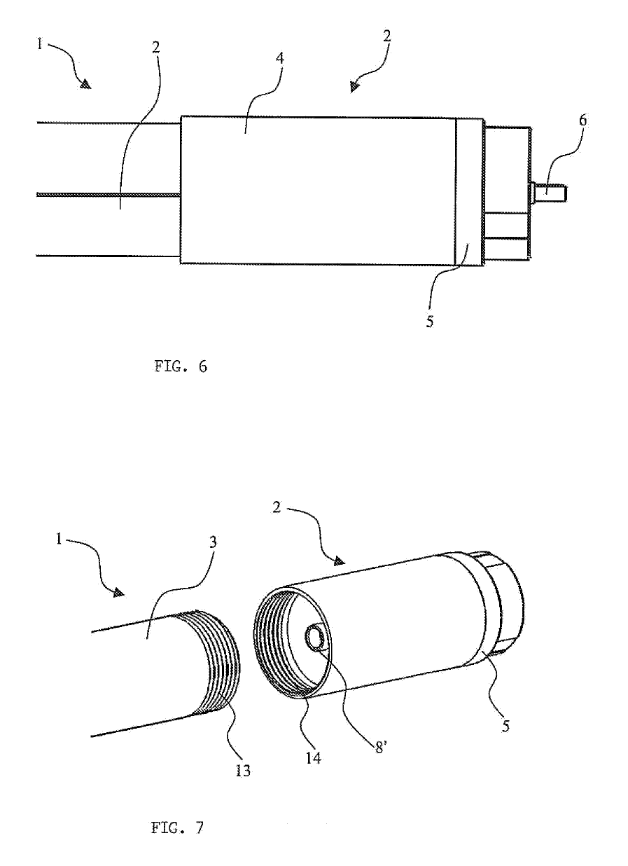

Specifically refer to FIGS. 4 and 5. FIGS. 4 and 5 show the electrical connection and mechanical connection between the LED driver module and the LED lamp body from two different angles according to the first embodiment of the present invention. In order to realize electrical connection between the two, the tube lamp shell 3 has a first contact 11, such as a plurality of plug-in portions 11 electrically connected to the LED assembly at an end inside the tube lamp shell, and the driver casing 4 has a second contact 8, which also may be called as an starter portion, electrically connected to the driver at an end facing the tube lamp shell 3. The first contact and the second contact are in pluggable contact. The second contact 8 protrudes from the driver casing 4, and is designed with three plug-in holes 12 thereon for electrical conductivity. These plug-in holes could contact plug-in portions 11 (only one plug-in portion is illustrated in the figure) to realize electrical connection. The first contact 11 and the second contact 8 can be contact sheets, contact points or spring contacts or contact rings and other contacts suitable for accomplishing electrical contact.

A second opening 9 for cooperating with the first opening 7 on the tube lamp shell 3 is opened between the two plug-in holes 12 on the second contact 8.

In assembling, the tube lamp shell 3 is nested in the driver casing 4, and meanwhile the second contact 8 of the driver casing 4 stretches into the tube lamp shell 3 to be in contact with the first contact of the LED assembly. At this time, the first opening 7 is aligned with the second opening 9 arranged on the second contact 8, and the screw 10 is screwed into the first opening 7 and the second opening 9 so as to removablely connect the tube lamp shell 3 and the driver casing 4. In disassembling, as shown in FIG. 2, the screw 10 is unscrewed so that the tube lamp shell 3 and the driver casing 4 are separated.

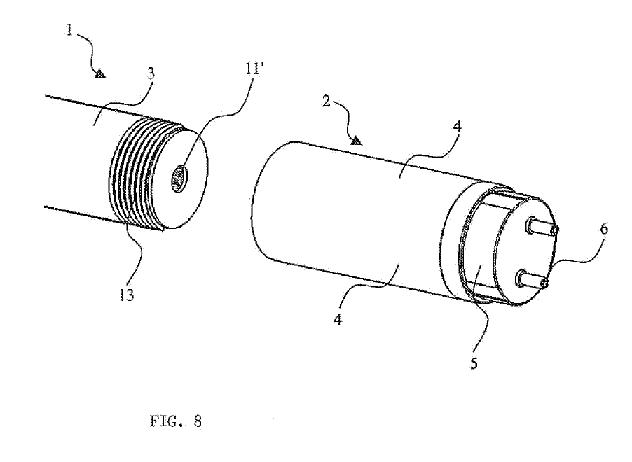

FIGS. 6, 7 and 8 show the electrical connection and mechanical connection between the LED driver module and the LED lamp body according to the second embodiment of the present invention. In this embodiment, the tube lamp shell 3 is provided with a first thread portion 13, the driver casing 4 is provided with a second thread portion 14, and the tube lamp shell 3 and the driver casing 4 are connected together, by screwing together the first thread portion 13 and second thread portion 14, so as to accomplish the mechanical connection between the two. Meanwhile, the electrical connection is accomplished by means of the first contact 11′ provided in the tube lamp shell 3 and the second contact 8′ provided in the driver casing 4. The first contact 11′ and the second contact 8′ can be contact sheets, contact points or spring contacts or contact rings and other contacts suitable for accomplishing the electrical contact.

Other manners also can be used for the electrical connection and mechanical connection, for instance, snap-fit connection also can be used for the mechanical connection.

The LED driver module can be one driver module at one end of the LED lamp body, and also can be two driver units at both ends of the LED lamp body, and the two driver units jointly form one driver module.

Though the present invention is described in combination with exemplary embodiments currently regarded as practical, the person skilled in the art could understand that the present invention is not limited to the exemplary embodiments disclosed herein. Any modification, equivalent substitution and improvement, etc., within the spirit and principle of the present invention should be comprised within the scope of protection of the present invention.

### REFERENCE SIGNS

1 LED lamp body
2 LED driver module
3 tube lamp shell
4 driver casing
5 end cover
6 base of the lamp
7 first opening
8,8′ second contact
9 second opening
10 screw
11,11′ first contact
12 plug-in hole
12 plug-in portion
13 first thread portion
14 second thread portion

1. A self-ballasted light emitting diode tube, comprising:
a light emitting diode lamp body; and
a light emitting diode driver module;
wherein the light emitting diode driver module is configured to drive the light emitting diode lamp body for lighting;
wherein the light emitting diode driver module and the light emitting diode lamp body are removably connected.

2. The self-ballasted LED tube according to claim 1, wherein the light emitting diode driver module is arranged at an end of the light emitting diode lamp body.

3. The self-ballasted LED tube according to claim 2, wherein the light emitting diode driver module comprises a first driver unit and a second driver unit respectively located at one of two ends of the light emitting diode lamp body.

4. The self-ballasted light emitting diode tube according to claim 1,
wherein the light emitting diode lamp body comprises a tube lamp shell and light emitting diode assembly arranged in the tube lamp shell, the light emitting diode driver module comprises a driver casing and a driver arranged in the driver casing, the tube lamp shell and the driver casing are nested and locked together to removably connect the light emitting diode driver module and the light emitting diode lamp body.

5. The self-ballasted light emitting diode tube according to claim 4,
wherein the tube lamp shell has first contacts at an end of the tube lamp shell which is electrically connected to the light emitting diode assembly, the driver casing has second contact electrically connected to the driver at an end facing the tube lamp shell, the first contacts and the second contacts are electrically contacted.

6. The self-ballasted light emitting diode tube according to claim 5,
wherein the first contacts and the second contact are one of spring contacts and contact rings.

7. The self-ballasted light emitting diode tube according to claim 5,
wherein the tube lamp shell comprises a first opening thereon, the second contact has a second opening thereon, the light emitting diode driver module and the light emitting diode lamp body are removably connected by aligning the first opening with the second opening and locking them with a locking means.

8. The self-ballasted light emitting diode tube according to claim 5,
wherein said locking means is screw.

9. The self-ballasted light emitting diode tube according to claim 5,
wherein the tube lamp shell comprises a first thread portion, the driver casing comprises a second thread portion, the light emitting diode driver module and the light emitting diode lamp body are removably connected by screwing together the first thread portion and the second thread portion.

10. A luminaire, comprising:
a self-ballasted light emitting diode tube, comprising:
a light emitting diode lamp body; and
a light emitting diode driver module;
wherein the light emitting diode driver module is configured to drive the light emitting diode lamp body for lighting;
wherein the light emitting diode driver module and the light emitting diode lamp body are removably connected.
